(19) United States
(12) Patent Application Publication
(10) Pub. No.: US 2021/0359756 A1
(43) Pub. Date: Nov. 18, 2021

(54) Light-Interactive System And Light-Interactive Control Method

(71) Applicants: Shanghai Etopia Building Technology Co., Ltd., Shanghai (CN); Hangzhou Shinyeasy Technology Co., Ltd., Hangzhou City (CN)

(72) Inventors: Yunsheng Su, Shanghai (CN); Xiao Zou, Shanghai (CN); Guanzhicheng Xia, Shanghai (CN); Guanlin Huang, Shanghai (CN)

(21) Appl. No.: 17/320,260

(22) Filed: May 14, 2021

(30) Foreign Application Priority Data
May 14, 2020 (CN) 202010409209.9

(51) Int. Cl. H04B 10/116; H04B 10/85; H04L 9/08; G06Q 20/40

(52) U.S. Cl. CPC H04B 10/116; H04B 10/85; G06Q 2220/00; G06Q 20/4014; H04L 9/0863

(57) ABSTRACT

The disclosure provides a light-interactive system and a light-interactive control method. The light-interactive system includes: a light-interactive jewelry, an intelligent terminal, a light receiving device, and a cloud; wherein the light-interactive jewelry receives a control instruction sent by the intelligent terminal, emits a light signal according to the control instruction, loads a random password onto the light signal to form an encrypted light signal, sends the encrypted light signal to the light receiving device, and sends the random password to the cloud; the light receiving device receives the encrypted light signal sent by the light-interactive jewelry, and sends a confirmation password in the received encrypted light signal to the cloud; the cloud matches the confirmation password with the random password, generates an operating instruction according to a matching result, and sends the operating instruction to the light receiving device; and the light receiving device further controls an intelligent hardware according to the operating instruction. The disclosure can realize contactless control on intelligent hardware and improve interaction safety and interaction efficiency.

### TECHNICAL FIELD

The disclosure relates to the technical field of information processing, in particular to a light-interactive system and a light-interactive control method.

### BACKGROUND

When facing highly contagious viruses, such as SARS virus and new coronavirus, the most important anti-epidemic measure is spatial isolation. Whether a concentrated isolation measure is taken in a community, a corridor, a home space, or a hospital, it is necessary to develop a new technology for an intelligent space management. At present, most space management methods adopt the modes of inputting a password, scanning a QR code with a mobile phone, swiping a door card, and face recognition. However, due to a user wearing a mask during the protection period, the face recognition cannot be performed, while means such as a fingerprint lock, a password, a QR code for mobile phone and NFC magnetic induction door card require behaviors of searching for and taking out items, and contacting public facilities by hand, which not only increases a possibility of being infected, but also has low safety, complex process and low efficiency.

### SUMMARY

Based on this, it is necessary to provide a light-interactive system and a light-interactive control method to realize contactless control for intelligent hardware and improve interaction security and interaction efficiency.

In order to achieve above objective, the disclosure provides the following solutions:

A light-interactive system comprises a light-interactive jewelry, an intelligent terminal, a light receiving device, and a cloud; wherein the light-interactive jewelry is configured to receive a control instruction sent by the intelligent terminal, emit a light signal according to the control instruction, load a random password onto the light signal to form an encrypted light signal, send the encrypted light signal to the light receiving device, and send the random password to the cloud; the light receiving device is configured to receive the encrypted light signal sent by the light-interactive jewelry, and send a confirmation password in the received encrypted light signal to the cloud; the cloud is configured to match the confirmation password with the random password, generate an operating instruction according to a matching result, and send the operating instruction to the light receiving device; and the light receiving device is further configured to control an intelligent hardware according to the operating instruction.

Optionally, the intelligent terminal is further configured to receive the operating instruction, generate a confirmation signal according to the operating instruction, and send the confirmation signal to the light receiving device; and the light receiving device is configured to control the intelligent hardware according to the operating instruction after receiving the confirmation signal.

Optionally, the light-interactive jewelry is a light-interactive ring or a light-interactive pendant.

Optionally, the light-interactive jewelry comprises a jewelry body, and a communication chip and an LED flash lamp arranged on the jewelry body; the communication chip is electrically connected with the LED flash lamp; the communication chip is configured to control the LED flash lamp to emit the light signal according to the control instruction, and load the random password onto the light signal to form the encrypted light signal; and

the communication chip comprises a first control circuit and a second control circuit; and the first control circuit and the second control circuit are connected through a flexible circuit board.

Optionally, the jewelry body is further provided with a flash trigger button, a capacitor and a battery; an outer surface of the jewelry body is provided with a decorative packaging shell; the flash trigger button is electrically connected with the communication chip and the LED flash lamp; and the capacitor and the battery are both connected with the communication chip.

Optionally, the jewelry body is further provided with a wireless charging coil; and the wireless charging coil is connected to the communication chip.

Optionally, the light receiving device comprises a light receiving element and a light sensor chip.

Optionally, the intelligent terminal has a built-in interactive APP; the interactive APP comprises a user login module, a light-interactive jewelry matching module, a payment limit determining module, a payment module and a time recording module; the user login module is configured to verify user information; the light-interactive jewelry matching module is configured to bind one or more light-interactive jewelry; the payment limit determining module is configured to determine an order amount to be paid; the payment module is configured to make a payment when the order amount to be paid is correct; and the time recording module is configured to record time when the light-interactive jewelry emits the light signal.

Optionally, the interactive APP further comprises an information confirming module; and the information confirming module is configured to confirm the operating instruction.

The disclosure further provides a light-interactive control method, comprising:

acquiring a control instruction sent by an intelligent terminal;

emitting a light signal according to the control instruction, and loading a random password onto the light signal to form an encrypted light signal;

sending the encrypted light signal to a light receiving device, and sending the random password to a cloud; and the light receiving device sending the encrypted light signal to the cloud; and

when a confirmation password in the encrypted light signal received by the cloud is consistent with a random password received by the cloud, the cloud sending an operating instruction to the light receiving device; and the light receiving device controlling an intelligent hardware according to the operating instruction, to realize an interaction between a user and the intelligent hardware.

Compared with the prior art, following beneficial effects of the disclosure can be obtained:

The disclosure provides a light-interactive system and a light-interactive control method. The light-interactive system includes: the light-interactive jewelry, the intelligent terminal, the light receiving device, and the cloud; wherein the light-interactive jewelry is configured to receive the control instruction sent by the intelligent terminal, emit the light signal according to the control instruction, load the random password onto the light signal to form the encrypted light signal, send the encrypted light signal to the light receiving device, and send the random password to the cloud; the light receiving device is configured to receive the encrypted light signal sent by the light-interactive jewelry, and send the confirmation password in the received encrypted light signal to the cloud; the cloud is configured to match the confirmation password with the random password, generate the operating instruction according to a matching result, and send the operating instruction to the light receiving device; and the light receiving device is further configured to control the intelligent hardware according to the operating instruction. The disclosure realizes the contactless control on the intelligent hardware based on a visible light wireless communication technology, and improves the interaction safety and interaction efficiency.

### BRIEF DESCRIPTION OF THE DRAWINGS

In order to explain the embodiments of the disclosure or the technical solutions in the prior art more clearly, the drawings needed in the embodiments will be briefly introduced below. Obviously, the drawings described below are only some embodiments of the disclosure. Other drawings can be obtained from these drawings for those ordinary skill in the art, without creative work.

FIG. 1 is a schematic structural diagram of a light-interactive system according to one embodiment of the disclosure;

FIG. 2 is a schematic structure diagram of a light-interactive ring at a first angle in a first form according to one embodiment of the disclosure;

FIG. 3 is a schematic structure diagram of a light-interactive ring at a second angle in a first form according to one embodiment of the disclosure;

FIG. 4 is a schematic structure diagram of a light-interactive ring in a second form according to one embodiment of the disclosure;

FIG. 5 is a schematic assembly structure diagram of a light-interactive ring in a third form according to one embodiment of the disclosure;

FIG. 6 is a schematic internal structure diagram of the light-interactive ring in the third form according to one embodiment of the disclosure;

FIG. 7 is a flowchart of the light-interactive control method according to one embodiment of the disclosure.

### DETAILED DESCRIPTION OF THE EMBODIMENTS

The technical solutions in the embodiments of the disclosure will be clearly and completely described below in conjunction with the accompanying drawings in the embodiments of the disclosure. Obviously, the described embodiments are only a part of the embodiments of the disclosure, rather than all the embodiments. Based on the embodiments of the disclosure, all other embodiments obtained by those ordinary skill in the art without creative work shall fall within the protection scope of the disclosure.

In order to make the above-mentioned objects, features and advantages of the disclosure more obvious and easy to understand, the disclosure will be further described in detail below in conjunction with the accompanying drawings and specific embodiments.

FIG. 1 is a schematic structural diagram of a light-interactive system according to one embodiment of the disclosure. Referring to FIG. 1, the light-interactive system according to this embodiment includes: a light-interactive jewelry, an intelligent terminal, a light receiving device, and a cloud. The light-interactive jewelry is configured to receive a control instruction sent by the intelligent terminal, emit a light signal (a stroboscopic signal) according to the control instruction, load a random password onto the light signal to form an encrypted light signal, send the encrypted light signal to the light receiving device, and send the random password to the cloud. The light receiving device is configured to receive the encrypted light signal sent by the light-interactive jewelry, and send a confirmation password in the received encrypted light signal to the cloud. The cloud is configured to match the confirmation password with the random password, generate an operating instruction according to a matching result, and send the operating instruction to the light receiving device. The light receiving device is further configured to control the intelligent hardware according to the operating instruction. The intelligent hardware can include various entrance controls, gates, door locks, ladder controls, vending machines, etc.

As an optional embodiment, the intelligent terminal is further configured to receive the operating instruction, generate a confirmation signal according to the operating instruction, and send the confirmation signal to the light receiving device. The light receiving device is configured to control the intelligent hardware according to the operating instruction after receiving the confirmation signal.

As an optional embodiment, the light-interactive jewelry is a light-interactive ring or a light-interactive pendant.

As an optional embodiment, the light-interactive jewelry includes a jewelry body, and a communication chip and an LED flash lamp arranged on the jewelry body. The communication chip is electrically connected with the LED flash lamp. The communication chip is configured to control the LED flash lamp to emit the light signal according to the control instruction, and load the random password onto the light signal to form the encrypted light signal. The communication chip includes a first control circuit and a second control circuit. The first control circuit and the second control circuit are connected through a flexible circuit board.

The jewelry body is further provided with a flash trigger button, a capacitor, and a battery. An outer surface of the jewelry body is provided with a decorative packaging shell. The flash trigger button is electrically connected to the communication chip and the LED flash lamp Both the capacitor and the battery are connected to the communication chip.

As an optional embodiment, the jewelry body is further provided with a wireless charging coil; and the wireless charging coil is connected to the communication chip.

As an optional embodiment, the light receiving device includes a light receiving element and a light sensor chip. The light receiving element may be a light shield or a light receiver.

As an optional embodiment, the light receiving device further includes a control. And the light sensor chip is connected to the intelligent hardware through the control.

As an optional embodiment, the intelligent terminal has a built-in interactive APP. The interactive APP includes a user login module, a light-interactive jewelry matching module, a payment limit determining module, a payment module and a time recording module. The user login module is configured to verify user information. The light-interactive jewelry matching module is configured to bind one or more light-interactive jewelries. The payment limit determining module is configured to determine an order amount to be paid. The payment module is configured to make a payment when the order amount to be paid is correct. And the time recording module is configured to record the time when the light-interactive jewelry emits the light signal.

As an optional embodiment, the interactive APP further includes an information confirming module. And the information confirming module is configured to confirm an operating instruction.

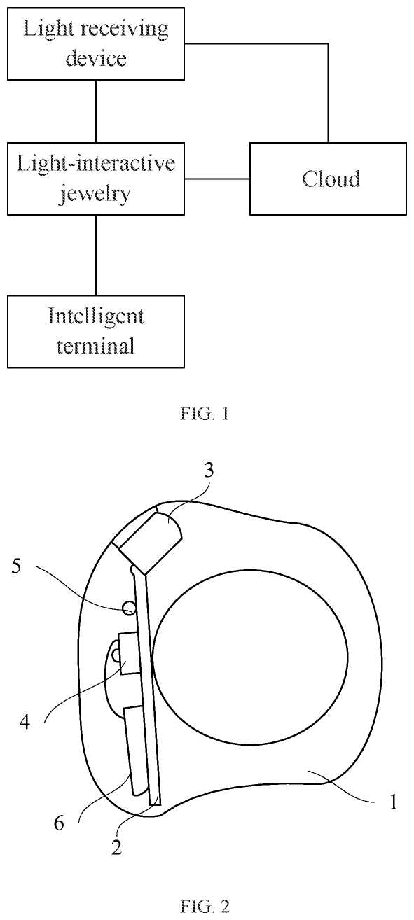

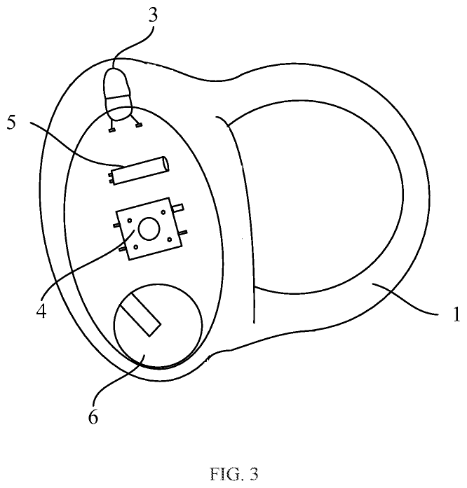

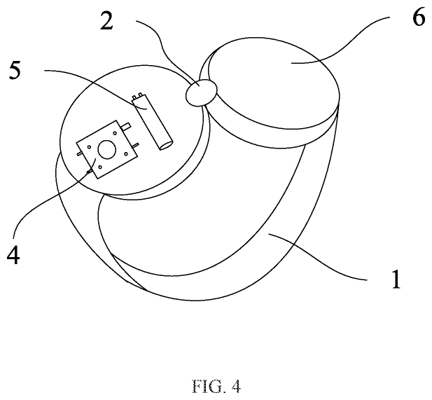

As an optional embodiment, as shown in FIGS. 2 and 3, the light-interactive ring includes a ring body 1, and a communication chip 2, an LED flash lamp 3, a flash trigger button 4, a capacitor 5 and a battery 6 arranged on the ring body 1. The communication chip 2 is electrically connected to the LED flash lamp 3. The communication chip 2 is configured to control the LED flash lamp 3 to emit a light signal according to a control instruction, and load a random password onto the light signal to form an encrypted light signal. The flash trigger button 4 is electrically connected to the communication chip 2 and the LED flash lamp 3 respectively. Both the capacitor 5 and the battery 6 are connected to the communication chip 2. The ring body 1 can be combined with a shape of a finger ring to make different changes. An outer surface of the ring body 1 is also provided with a decorative packaging shell 8. The flash trigger button 4 is located on a side convenient for thumb triggering when worn. The ring body 1 may be a ring circle with a tray.

The communication chip 2 in the light-interactive ring can be set as a connecting body structure with an elastic structure in the middle, which is convenient to adapt to different finger thicknesses. The battery 6 and the flash trigger button 4 are located on both sides of the communication chip 2 respectively. The schematic structure diagram of the light-interactive ring in this embodiment is shown in FIG. 4. In this embodiment, the communication chip 2 includes a first control circuit and a second control circuit. The first control circuit and the second control circuit are connected through a flexible circuit board.

The battery 6 provided on the ring body 1 provides electrical energy for electrical components on the ring body 1. The battery 6 may be a button battery, and one button battery can be used continuously for more than one year, which ensures that the volume of the light-interactive ring can realize the interactive function.

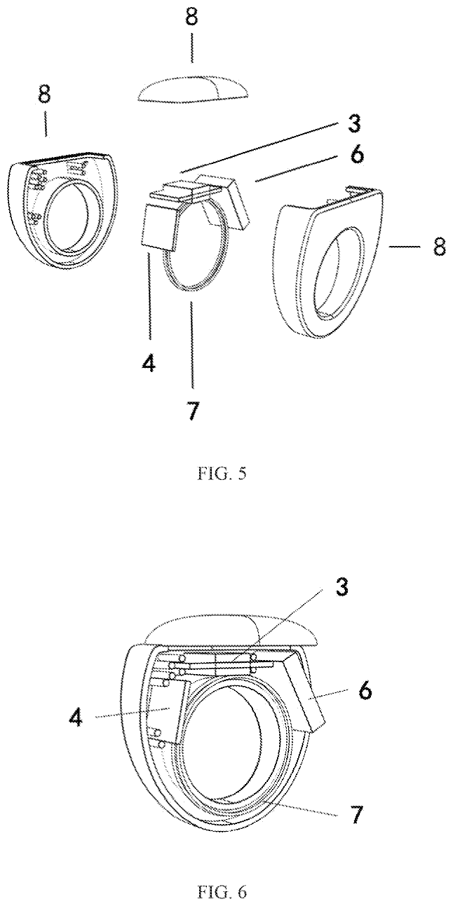

As shown in FIGS. 5-6, the ring body 1 may also be provided with a wireless charging coil 7. The wireless charging coil 7 is connected to the communication chip 2 to provide wireless charging for the electrical components on the ring body 1.

The light-interactive jewelry in this embodiment has following advantages:

1) Comparison with facial scanning technology.

The user, such as a doctor, can wear a mask or even a protective suit, and wear the light-interactive jewelry outside the protective suit and gloves to identify the user's identity and reach different space partitions, without taking out a mobile phone or a door card, or taking off gloves.

In crowded areas such as airports and railway stations, or in the process of facial recognition consumption payment in a densely populated shopping mall or a restaurant, a comparison method of ID card and facial recognition will reduce the passing efficiency on the one hand, and on the other hand it will be inconvenient for the user to remove the mask in crowded areas during the epidemic period.

Because the light-interactive jewelry is bound to the intelligent terminal (such as the mobile phone), and the software on the mobile phone can be authenticated by the Ministry of Public Security, and the identity of the user can be confirmed by using the mobile phone to scan the face of the user, which avoids the massive abuse of face recognition on public equipment, the identity of the user can be quickly identified.

2) Comparison with touch button technology.

At present, the elevator buttons are a main infection source due to cross uses of different people thereof. Furthermore, password locks and fingerprint locks also require the user to touch hardware such as door locks.

Using the light-interactive jewelry to control the elevator, as long as the floor is preset in the mobile phone, and the light-interactive jewelry flashes to the light receiver once, the elevator can automatically reach the preset floor. Furthermore, preset different floors can be selected by flashing several times in one second. Especially in public areas, the use of contactless interactive methods, such as the light-interactive jewelry, has great advantages

3) Comparison with the traditional magnetic card interaction.

The one card in the traditional unit can be used for space management or meal card. However, permission management in many scenarios requires background management, which is inconvenient for distributed management. Take the elevator as an example, the traditional magnetic card can only correspond to one floor, a floor change requires complicated background operations. Therefore, management through mobile phones has obvious advantages The use of the meal card in a canteen also requires a service staff to set a consumption amount and then the user pay by swiping the card.

In a case that the light-interactive jewelry is adopted, the light-interactive jewelry can be interacted with the mobile phone APP at any time, and the user only needs to actively set the consumption amount on the mobile phone in the software to achieve payment by light flash.

4) Comparison with the mobile phone QR code interaction.

The QR code technology requires using the mobile phone to start the software and open the QR code so that a capturing device takes a photo to identify the QR code, which is a cumbersome service process. Furthermore, due to the QR code being a plain code, the QR code has poor information capacity, confidentiality and non-replicability.

In contrast, the light-interactive jewelry can transmit 2000+ bit information within one second per button, and the code will be randomly selected every time it flashes, which is very confidential.

The light-interactive system of this embodiment can send the light signal and the random password to the light receiving device through LED strobes, and at the same time send the random password to the cloud. The light receiver can filter interference information in the ambient light to obtain a strobe signal sent by the LED flash lamp, send the confirmation password to the cloud to check the confirmation password with the random password sent by the light-interactive jewelry. If the confirmation password matches with the random password, the light receiver transmits the instruction information of the light-interactive jewelry to the intelligent hardware, and the intelligent hardware executes the instruction. The communication chip in the light-interactive jewelry is paired with the intelligent terminal, to set a permission, a payment amount, and an use time of each light-interactive jewelry through the APP port on the intelligent terminal. One mobile intelligent terminal can authorize and control multiple light-interactive jewelry. And each interaction of each ring is recorded on the APP of the mobile phone.

The light-interactive system of this embodiment realizes contactless control for intelligent hardware based on visible light wireless communication technology, which has achieved effects of power saving, convenience and improved interaction safety and interaction efficiency. Compared with existing watches, bracelets, magnetic cards, etc., the light-interactive jewelry is more convenient to wear, not easy to lose, and does not require daily charging. Especially when users of respiratory infectious diseases need to wear masks, it is more convenient to identify the identity of the user in hospitals, transportation hubs and other scenarios.

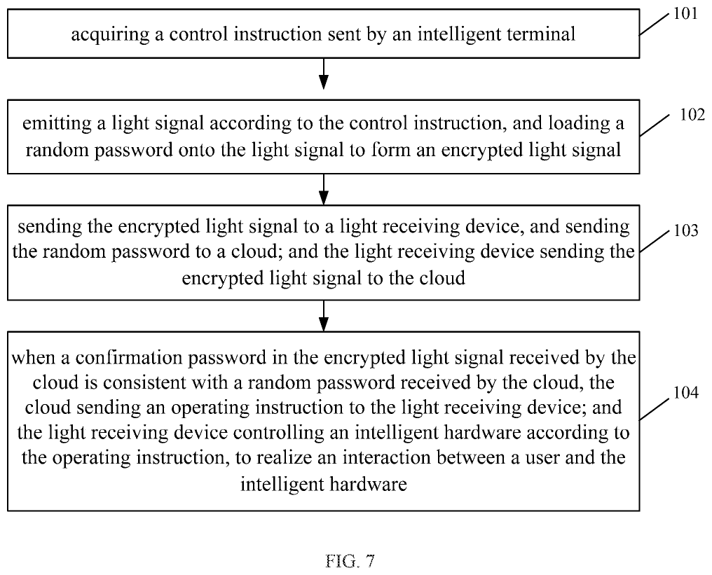

FIG. 7 is the flowchart of the light-interactive control method according to one embodiment of the disclosure. Referring to FIG. 7, the light-interactive control method of this embodiment includes:

Step 101: acquiring a control instruction sent by an intelligent terminal;

Step 102: emitting a light signal according to the control instruction, and loading a random password onto the light signal to form an encrypted light signal;

Step 103: sending the encrypted light signal to a light receiving device, and sending the random password to a cloud; and the light receiving device sending the encrypted light signal to the cloud; and

Step 104: when a confirmation password in the encrypted light signal received by the cloud is consistent with a random password received by the cloud, the cloud sends an operating instruction to the light receiving device; and the light receiving device controls an intelligent hardware according to the operating instruction, to realize an interaction between a user and the intelligent hardware.

As an optional embodiment, the light-interactive control method further includes:

the intelligent terminal receiving the operating instruction, generating a confirmation signal according to the operating instruction, and sending the confirmation signal to the light receiving device; after receiving the confirmation signal, the light receiving device controlling the intelligent hardware according to the operating instruction. In this way, when the light-interactive jewelry is lost and an authorization on the intelligent terminal is not closed, the security of the interaction can be ensured.

A more specific embodiment is provided below.

The light-interactive control method in this specific embodiment specifically includes:

(1) the light-interactive jewelry is paired with an intelligent phone. Through intelligent operation of a mobile phone, the light-interactive jewelry is ensured to be bound to the mobile phone one-to-one. The light-interactive jewelry is bound to bank cards, credit cards, WeChat payment, Alipay, etc. through the APP on the mobile phone, to preset payment limits, permissions, etc. The light-interactive jewelry interacts with the intelligent hardware by being bound to door locks and door opening permissions by the mobile phone. Face recognition is done through the mobile phone camera, and then face information is bound to a specific light-interactive jewelry. In this way, the user can complete door opening, payment, shopping and other activities only by the light-interactive jewelry, without taking out the mobile phone. This method realizes the interaction between users and different intelligent hardware through a piece of hardware.

(2) When the trigger button of the light-interactive jewelry is pressed with the light-interactive jewelry facing the light receiver of the intelligent hardware, the light-interactive jewelry emits a light carrying a random password, and sends an instruction (such as the random password) to the cloud at the same time. When a light loaded with the random password is received by the light receiving device, the light receiving device sends the confirmation password in the light loaded with the random password to the cloud. After the instructions of the light-interactive jewelry and the light receiving device are matched correctly in the cloud, the light receiving device receives the instruction, and executes an order. Therefore, the light-interactive jewelry can work independently from the associated mobile phone.

(3) Once the light-interactive jewelry is lost, the light-interactive jewelry can be invalidated by turning off an authorization on the mobile phone.

Specific embodiments are used herein to illustrate the principles and implementations of the disclosure. The description of the above embodiments is only used to help understanding the method and core idea of the disclosure. At the same time, according to the idea of the disclosure, there will be changes in a specific implementation and an application scope for those ordinary skill in the art. In summary, the content of this specification should not be construed as limiting the disclosure.

1. A light-interactive system, comprising: a light-interactive jewelry, an intelligent terminal, a light receiving device, and a cloud; wherein the light-interactive jewelry is configured to receive a control instruction sent by the intelligent terminal, emit a light signal according to the control instruction, load a random password onto the light signal to form an encrypted light signal, send the encrypted light signal to the light receiving device, and send the random password to the cloud; the light receiving device is configured to receive the encrypted light signal sent by the light-interactive jewelry, and send a confirmation password in the received encrypted light signal to the cloud; the cloud is configured to match the confirmation password with the random password, generate an operating instruction according to a matching result, and send the operating instruction to the light receiving device; and the light receiving device is further configured to control an intelligent hardware according to the operating instruction.

2. The light-interactive system according to claim 1, wherein the intelligent terminal is further configured to receive the operating instruction, generate a confirmation signal according to the operating instruction, and send the confirmation signal to the light receiving device; and the light receiving device is configured to control the intelligent hardware according to the operating instruction after receiving the confirmation signal.

3. The light-interactive system according to claim 1, wherein the light-interactive jewelry is a light-interactive ring or a light-interactive pendant.

4. The light-interactive system according to claim 1, wherein the light-interactive jewelry comprises a jewelry body, and a communication chip and an LED flash lamp arranged on the jewelry body; the communication chip is electrically connected with the LED flash lamp; the communication chip is configured to control the LED flash lamp to emit the light signal according to the control instruction, and load the random password onto the light signal to form the encrypted light signal; and
the communication chip comprises a first control circuit and a second control circuit; and the first control circuit and the second control circuit are connected through a flexible circuit board.

5. The light-interactive system according to claim 4, wherein the jewelry body is further provided with a flash trigger button, a capacitor and a battery; an outer surface of the jewelry body is provided with a decorative packaging shell; the flash trigger button is electrically connected with the communication chip and the LED flash lamp; and the capacitor and the battery are both connected with the communication chip.

6. The light-interactive system according to claim 4, wherein the jewelry body is further provided with a wireless charging coil; and the wireless charging coil is connected to the communication chip.

7. The light-interactive system according to claim 1, wherein the light receiving device comprises a light receiving element and a light sensor chip.

8. The light-interactive system according to claim 1, wherein the intelligent terminal has a built-in interactive APP; the interactive APP comprises a user login module, a light-interactive jewelry matching module, a payment limit determining module, a payment module and a time recording module; the user login module is configured to verify user information; the light-interactive jewelry matching module is configured to bind one or more light-interactive jewelry; the payment limit determining module is configured to determine an order amount to be paid; the payment module is configured to make a payment when the order amount to be paid is correct; and the time recording module is configured to record time when the light-interactive jewelry emits the light signal.

9. The light-interactive system according to claim 8, wherein the interactive APP further comprises an information confirming module; and the information confirming module is configured to confirm the operating instruction.

10. A light-interactive control method, comprising:
acquiring a control instruction sent by an intelligent terminal;
emitting a light signal according to the control instruction, and loading a random password onto the light signal to form an encrypted light signal;
sending the encrypted light signal to a light receiving device, and sending the random password to a cloud; and the light receiving device sending the encrypted light signal to the cloud; and
when a confirmation password in the encrypted light signal received by the cloud is consistent with a random password received by the cloud, the cloud sending an operating instruction to the light receiving device; and the light receiving device controlling an intelligent hardware according to the operating instruction, to realize an interaction between a user and the intelligent hardware.
